(19) United States
(12) Patent Application Publication
(10) Pub. No.: US 2014/0028982 A1
(43) Pub. Date: Jan. 30, 2014

(54) PROJECTION WITH SEMICONDUCTOR LIGHT SOURCES, DEFLECTION MIRROR AND TRANSMITTED-LIGHT REGIONS

(71) Applicant: OSRAM GmbH, Muenchen (DE)

(72) Inventor: Stefan Hadrath, Falkensee (DE)

(73) Assignee: OSRAM GmbH, Muenchen (DE)

(21) Appl. No.: 13/953,863

(22) Filed: Jul. 30, 2013

(30) Foreign Application Priority Data
Jul. 30, 2012 (DE) 10 2012 213 311.9

(51) Int. Cl. G03B 21/28

(52) U.S. Cl. CPC G03B 21/28
USPC 353/20; 353/98; 353/121

(57) ABSTRACT

In various embodiments, a projection device is provided. The projection device may include a light generator for generating primary light by means of at least one light source; at least one carrier having a plurality of transmitted-light regions, the front sides of which can be irradiated by the primary light and the rear sides of which emit light, which transmitted-light regions have at least one first transmitted-light region which contains luminophore and the front side of which can be illuminated by the primary light and the rear side of which emits wavelength-converted secondary light; and at least one deflection mirror for deflecting the primary light of the light generator onto a respective transmitted-light region; wherein the transmitted-light regions have at least one further, wavelength-invariant transmitted-light region.

### CROSS-REFERENCE TO RELATED APPLICATION

This application claims priority to German Patent Application Serial No. 10 2012 213 311.9, which was filed Jul. 30, 2012, and is incorporated herein by reference in its entirety.

### TECHNICAL FIELD

Various embodiments relate to a projection device, including a light generator for generating primary light by means of at least one light source, at least one carrier having a plurality of transmitted-light regions, the front sides of which can be irradiated by the primary light and the rear sides of which emit light, which transmitted-light regions have at least one first transmitted-light region which contains luminophore and the front side of which can be illuminated by the primary light and the rear side of which emits wavelength-converted secondary light, and including at least one deflection minor for deflecting the primary light of the light generator onto a respective transmitted-light region. Various embodiments are applicable, for example, to image projectors or vehicle headlights.

### BACKGROUND

DE 195 30 008 B4 discloses a lighting apparatus for vehicles including a reflective deflection device, including at least one light source and including at least one reflector through which light emitted by the at least one light source is reflected, wherein the reflective deflection device is arranged in the beam path of the light reflected by the at least one reflector, and wherein light impinging on the reflective deflection device, for forming a light beam emerging from the lighting apparatus, experiences a reflection, wherein the deflection device has a multiplicity of individual reflective elements which can be changed over between at least two defined positions independently of one another.

US 2006/221021 A1 discloses fluorescent screens and display systems and apparatuses based on such screens using a least one optical excitation beam in order to excite one or a plurality of fluorescent materials (luminophores) on a screen which emit light in order to generate images. The fluorescent materials may include phosphor materials and non-phosphor materials such as e.g. quantum dots. A screen can have a multilayered dichroic layer.

US 2011/249460 A1 discloses a vehicle headlight including a common light distribution unit and a variable light distribution unit, and a headlight system including a headlight may form a common light distribution pattern and a variable light distribution pattern, to be precise using the common light distribution unit and the variable light distribution unit. The variable light distribution unit may have a light source, a luminophore plate, a mirror for reflecting/scanning light emitted by the light source onto the luminophore plate and a projector lens for projecting the scanned light in a manner adjacent to the common light distribution patterns.

### SUMMARY

In various embodiments, a projection device is provided. The projection device may include a light generator for generating primary light by means of at least one light source; at least one carrier having a plurality of transmitted-light regions, the front sides of which can be irradiated by the primary light and the rear sides of which emit light, which transmitted-light regions have at least one first transmitted-light region which contains luminophore and the front side of which can be illuminated by the primary light and the rear side of which emits wavelength-converted secondary light; and at least one deflection mirror for deflecting the primary light of the light generator onto a respective transmitted-light region; wherein the transmitted-light regions have at least one further, wavelength-invariant transmitted-light region.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a projection device according to the invention as a sectional illustration in side view; and

FIG. 2 shows in frontal view a carrier of the projection device occupied by transmitted-light regions.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments at least partly overcome the disadvantages of the prior art.

Various embodiments provide a projection device, including a light generator for generating excitation light or primary light by means of at least one light source, at least one carrier having a plurality of transmitted-light regions, the first sides (“front sides”) of which may be irradiated by the primary light and the second sides (“rear sides”) of which emit light, which transmitted-light regions have at least one first transmitted-light region which contains luminophore and the front side of which may be illuminated by the primary light and the rear side of which emits wavelength-converted secondary light, and including at least one deflection mirror for deflecting the primary light of the light generator onto a respective transmitted-light region, wherein the transmitted-light regions have at least one further, wavelength-invariant transmitted-light region.

A simply constructed lighting device which may provide particularly diverse light emission patterns is provided by means of this projection device. In this regard, choosing the type and arrangement of the transmitted-light regions already makes it possible to provide diverse light emission patterns behind the carrier or at the rear of the at least one carrier. Moreover, this projection device makes it possible to provide different light emission patterns by individual illumination of the transmitted-light regions. Moreover, direct admixing of primary light into the useful light generated behind the carrier is made possible in this way. As a result, firstly luminophore can be saved, and it is possible to achieve a higher efficiency than with exclusive use of wavelength conversion.

A wavelength-invariant transmitted-light region may be understood to mean, for example, a transmitted-light region which does not convert the wavelength of the light radiating through it, that is to say in particular does not include a luminophore sensitive to the incident light. Incident primary light therefore remains, for example upon passing through the wavelength-invariant transmitted-light region, the same light having the same wavelength or spectral distribution.

In principle, the light generator may be any type of light generating unit. In various embodiments, the light generator may be a semiconductor light generator having at least one semiconductor light source. For generating the primary light, the semiconductor light generator may also have different semiconductor light sources that emit different primary light. The primary light may include e.g. visible light, infrared light (IR LED) or ultraviolet light (UV LED).

In various embodiments, the at least one semiconductor light source includes at least one light-emitting diode. The at least one light-emitting diode may be present in the form of at least one individually packaged light-emitting diode or in the form of at least one LED chip. A plurality of LED chips may be mounted on a common substrate (“submount”). The at least one light-emitting diode may be equipped with at least one dedicated and/or common optical unit for beam guiding, e.g. at least one Fresnel lens, collimator, and so on. Instead of or in addition to inorganic light-emitting diodes, e.g. on the basis of InGaN or AlInGaP, generally organic LEDs (OLEDs, e.g. polymer OLEDs) may also be used.

Alternatively or additionally, the at least one semiconductor light source may include at least one laser, in particular diode laser. Said laser has a particularly sharp light beam, which simplifies illumination of the transmitted-light regions. Moreover, its illuminance with regard to a transmitted-light region is particularly high.

A proportion of the light emitted from the rear side of a transmitted-light region or its radiation power in comparison with a proportion of light emitted from the front side may be in particular at least 10%, e.g. at least 50% (a large portion of the light emitted from the transmitted-light region is emitted from the rear side), e.g. at least 70%, e.g. at least 90%, e.g. 100% (complete transmission).

In various embodiments, only the light emitted on the rear side of the at least one carrier is used as useful light. The light emitted on the front side may remain unused, for example.

The first transmitted-light region may include one or a plurality of luminophores. A luminophore is able to wholly or partly convert primary light incident on it into secondary light having a different, e.g. greater, wavelength. A degree of conversion depends, for example, on a density of the luminophore in a luminophore body and the thickness of said luminophore body. In various embodiments, the first transmitted-light region may include a luminophore body having a plate-like or disk-like basic form. The luminophore body may be present as a layer, for example. A form of the outer contour of the luminophore body is arbitrary and may be circular or rectangular, for example.

The fact that the first transmitted-light region emits wavelength-converted secondary light at its rear side may mean, in the case of full conversion, that it emits only secondary light. In the case of partial conversion, both secondary light and primary light are emitted at the rear side. These two proportions of light generate a mixed light. By way of example, a blue-yellow or white mixed light may be generated in the case of partial conversion of blue primary light into yellow secondary light.

The at least one further transmitted-light region needs to be embodied differently than the first transmitted-light region merely to the effect that the light emitted by it on the rear side is different, in particular with regard to light intensity, emission angle and/or color.

In one development, the at least one deflection mirror has at least one micromirror array, e.g. a surface light modulator composed of micromirror actuators arranged in a matrix-type fashion, e.g. a so-called DMD (“Digital Micromirror Device”). One advantage of the surface light modulator is that the transmitted-light regions irradiated by the surface light modulator can be illuminated simultaneously and in a pixel-like fashion. This enables simple driving and high switching rates. An optical unit for beam expansion may be disposed upstream of a surface light modulator, for example.

In another development, the at least one deflection mirror includes at least one oscillating mirror or “flying-spot” mirror. The at least one oscillating mirror directs a, usually narrow, light beam onto a transmitted-light region. As a result of the movement of the at least one oscillating mirror, the transmitted-light regions are successively irradiated or scanned, e.g. in a raster-like fashion. The use of an oscillating mirror may have the advantage that a primary light beam need not be expanded. This simplifies e.g. the use of a laser as primary light source. Moreover, a high luminance is thus provided at the transmitted-light region using comparatively simple means.

In one configuration, at least one further transmitted-light region includes luminophore that differs from the luminophore of the first transmitted-light region. As a result, the transmitted-light regions may emit light of different color, e.g. mixed color, as useful light or at the rear.

By way of example, the light generator may emit blue primary light, the luminophore of a first transmitted-light region may be a blue-green converting luminophore, and the luminophore of a further transmitted-light region may be a blue-red converting luminophore. In a further example, the light generator emits ultraviolet primary light, the luminophore of a first transmitted-light region may be a UV-blue converting luminophore, the luminophore of a further transmitted-light region is a UV-green converting luminophore, and yet another transmitted-light region comprises a UV-red converting luminophore.

In another configuration, at least one further transmitted-light region is a transparent and/or diffuse transmitted-light region. The transparent transmitted-light region may be an open feedthrough, for example, or may have a transparent cover or window (e.g. a glass or plastic lamina). In the case of a light-transmissive, in particular transparent, carrier, such a luminophore region may be e.g. a region left free of luminophore. Therefore, transparent transmitted-light regions and diffuse transmitted-light regions can also be present on a carrier.

In yet another configuration, at least one further transmitted-light region has a polarizer. Rear emission of useful light polarized in a targeted manner is thereby made possible.

The transmitted-light regions may include one or more of the elements presented above (luminophore, polarizer, etc.). In addition, the transmitted-light regions are not restricted thereto, but rather may include for example a color filter, etc.

In one development, the transmitted-light regions are arranged uniformly in a matrix-like fashion. The transmitted-light regions are therefore arranged for example in a rectangular grid. However, not every grid position or matrix position need be occupied by a transmitted-light region. An outer contour may be arbitrary. The matrix-like arrangement facilitates simple and regular illumination, e.g. by means of a micromirror array and a flying-spot arrangement.

Furthermore, in one configuration, the transmitted-light regions are arranged uniformly in a matrix-like fashion. This may mean, for example, that the transmitted-light regions form a specific basic pattern and the entire matrix array is constructed from this basic pattern, that is to say uniformly. By way of example, a basic pattern may be a 2×2 matrix having a transparent transmitted-light region, a blue-green converting transmitted-light region (which therefore comprises a corresponding luminophore), a blue-red converting transmitted-light region and a blue-yellow converting transmitted-light region. Said basic pattern may be continued fifty times in each direction in the plane, for example, in order to form in total a 100×100 overall matrix composed of transmitted-light regions. This configuration may have the advantage that a pixel-like light emission pattern can thus be generated behind the carrier. Given a sufficiently high density of the transmitted-light regions, in particular light of the transmitted-light regions of a basic pattern may be perceived as mixed light. A basic pattern may then be regarded and driven as a multicolor pixel. Particularly if each transmitted-light region can be irradiated individually and, if appropriate, even with an individually adjustable brightness or light intensity, it is thus possible to generate pixels with color and brightness set in a targeted manner.

A basic pattern may also have only one transmitted-light region.

In one configuration, in addition, the transmitted-light regions are arranged uniformly in a matrix-like fashion in partial areas. In this case, the basic patterns are identical only in one part (one partial area) of the entire matrix array and, in another part (another partial area), although they are identical among one another, they are different respect to the first partial area. Thus, for different partial areas, the type of pixels that is defined by the construction of the basic regions can be configured differently. This in turn enables a light emission pattern that may be fashioned particularly diversely.

In one configuration, moreover, the projection device, e.g. a carrier thereof, includes two partial areas (in particular of an overall matrix pattern) having an identical arrangement of transmitted-light regions, wherein the transmitted-light regions of the two partial areas may emit light of anaglyphic complementary colors (e.g. red and blue or red and cyan). This allows a simple generation of 3D images (anaglyph images).

In one development for enabling a representation of three-dimensional images, the projection device, e.g. a carrier thereof, includes two partial areas (in particular of an overall matrix pattern) having an identical arrangement of transmitted-light regions, wherein the transmitted-light regions of the two partial areas may emit light having a different polarization.

In one configuration, in addition, the at least one carrier is exchangeable, e.g. insertable or introducible. This enables the light emission pattern to be changed particularly simply and diversely. By way of example, one carrier may be exchanged for another carrier having different-sized transmitted-light regions, as a result of which a resolution of the light emission pattern may be changed. By way of example, one carrier may be exchanged for another carrier having transmitted-light regions including different luminophores, as a result of which a color space of the light emission pattern may be changed.

In another configuration, the at least one carrier includes a plurality of carriers arranged one behind another. This enables, in a compact manner, an even more diverse configuration of the light emission pattern.

In a further configuration, the transmitted-light regions of different carriers are arranged in series one behind another (congruently). In this regard, a light spot of a useful light or useful light beam generated behind the carriers may have a plurality of different properties in a simple manner. By way of example, a carrier may have transmitted-light regions including luminophore and a carrier arranged congruently with respect thereto may have transmitted-light regions equipped with a polarizer. In this regard, it is possible using simple means for a light spot of the useful light both to be configured in color and to be polarized.

In order to achieve a high luminous intensity of a light spot of the useful light, it is preferred for only one transmitted-light region of a series of transmitted-light regions (which are therefore arranged serially or in series in a common light path) to include luminophore.

In a further configuration, at least one carrier is a light-transmissive plate or disk. As a result, said carrier may be produced and coated particularly simply (e.g. with a luminophore layer, polarization layer, antireflection layer etc.), and need not be machined with material removal in a complex manner. The plate can consist for example of glass, synthetically produced sapphire crystal (“sapphire glass”), light-transmissive plastic, glass ceramic or light-transmissive ceramic. In various embodiments, a carrier composed of glass, glass ceramic and especially sapphire glass or transparent ceramic enables good heat dissipation.

The carrier may be transparent, for example, but for light homogenization may also be translucent (opaque).

Alternatively, the carrier may be, for example, a plate having a, more particularly light-opaque, main body into which holes are introduced as passage regions. The holes can then be filled or covered e.g. with luminophore.

In yet another configuration, at least one carrier is an optical transmitted-light element. It is thereby possible to combine a setting of a type (pixel arrangement, color, polarization, etc.) of the useful light and beam shaping of the useful light in a single component, which enables a particularly compact design.

The optical transmitted-light element may be a lens, for example.

Generally, an imaging optical unit composed of one or a plurality of optical elements (e.g. having one or a plurality of lenses, one or a plurality of reflectors, etc.) may be disposed downstream of the at least one carrier.

The projection device may be used for example as an image projector, e.g. for representing images or films. However, the projection device may also be used as a vehicle projector, e.g. as a front headlight, e.g. of a vehicle. As a result, diverse light emission patterns can be generated in a simple manner. The light emission patterns can be adapted e.g. to different light functions, such as e.g. to a low-beam light function having a first form and color, to a high-beam light function having a second form and color, etc.

Various embodiments provide a method for operating a projection device as described above, wherein the transmitted-light regions may be illuminated individually. This enables a variable, in particular pixel-like, construction of the light emission pattern. The method may be configured analogously to the projection device.

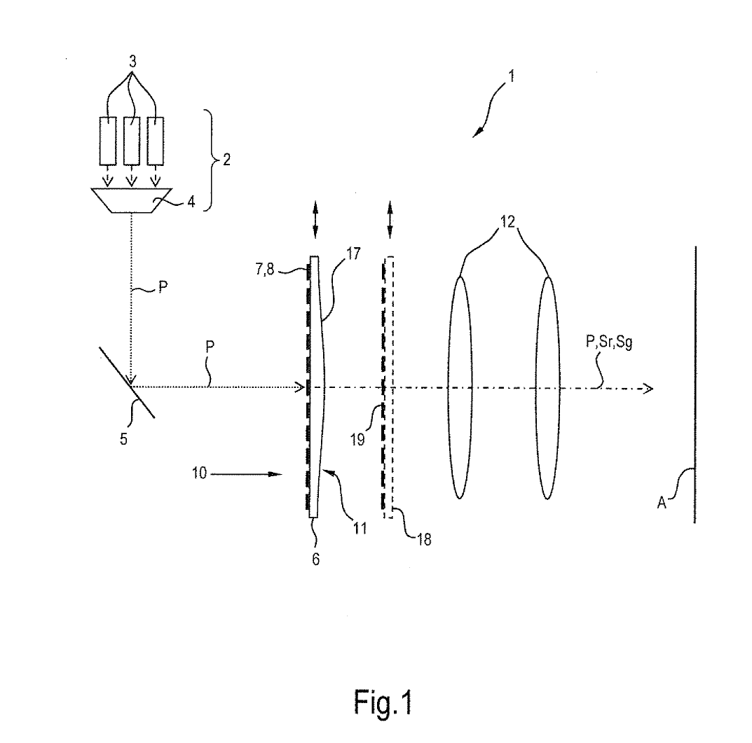

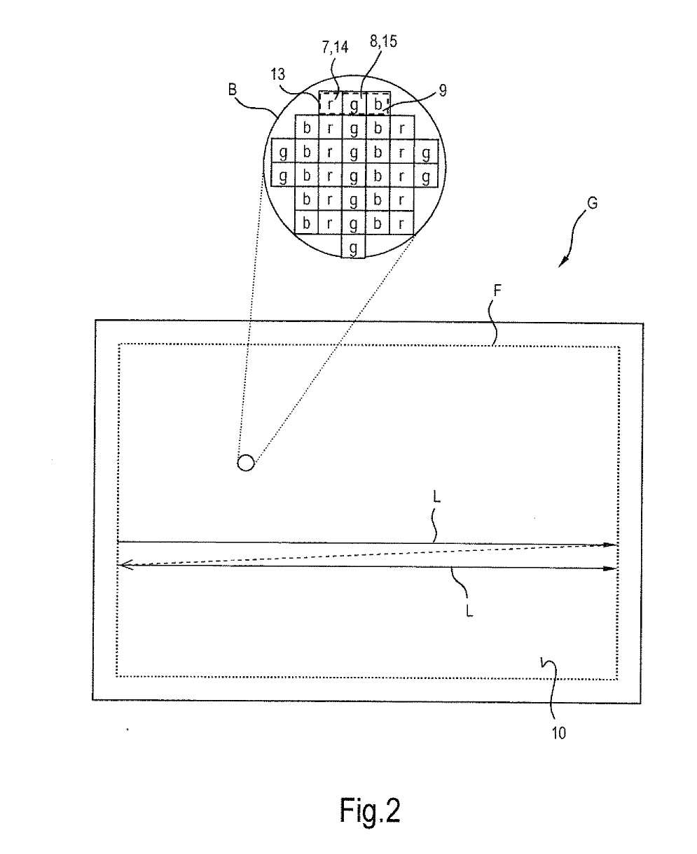

FIG. 1 shows a projection device 1, including a semiconductor light generator 2 for generating blue primary light P by means of a plurality of semiconductor light sources in the form of lasers 3. An optical unit 4 for beam combining is disposed downstream of the lasers 3. The combined beam of the primary light P emerging from said optical unit 4 radiated onto an or one of a plurality of oscillating mirrors 5 of a flying-spot arrangement. The at least one mirror 5 projects the beam of the primary light P onto an at least roughly plate-like carrier 6 composed of sapphire glass, to be precise for example with horizontal line scanning L, as shown in FIG. 2.

The carrier 6 has, as shown in an enlarged fashion in the region B in FIG. 2, an array F including transmitted-light regions 7, 8, 9 arranged in a matrix-like fashion. The transmitted-light regions 7, 8, 9 may be individually irradiated by the beam of the primary light P at the front side 10. In this case, a light intensity of a primary light P incident on a transmitted-light region 7, 8, 9 may be set individually, e.g. by setting a current intensity and/or a switch-on time of the lasers 3 during an illumination. In various embodiments, a transmitted-light region 7, 8, 9 may also not be illuminated.

The transmitted-light regions 7, 8, 9 emit (useful) light at the rear side 11, said light being projected onto an (external) image area F by a projection optical unit, indicated here by two lenses 12. Through the use of the at least one oscillating mirror 5, the transmitted-light regions 7, 8, 9 are irradiated successively, such that a light emission pattern is constructed serially by light spots. Each light spot is generated by the light emitted by a respective one of the transmitted-light regions 7, 8, 9 on the rear side. The transmitted-light regions 7, 8, 9 are arranged uniformly in a matrix-like fashion in such a way that three transmitted-light regions 7, 8, 9 form a specific basic pattern 13 in the form of a 3×1 matrix (depicted by dashed lines) and the entire array F is constructed uniformly from said basic pattern 13.

The transmitted-light region 7 has a luminophore layer 14 applied on the front side of the carrier 6, which luminophore layer converts the wavelength of the blue primary light P at least substantially completely into red secondary light Sr and emits the latter at the rear side 11. The transmitted-light region 8 has a luminophore layer 15 applied on the front side of the carrier 6, which luminophore layer converts the wavelength of the blue primary light P at least substantially completely into green secondary light Sg and emits the latter at the rear side 11. The transmitted-light region 9 is uncoated, that is to say is formed only by the transparent carrier 6, such that blue primary light P which has passed through the carrier 6 unimpeded is emitted at the rear side.

The transmitted-light regions 7, 8, 9 are irradiated with the primary light P temporally directly successively and form a logical pixel which therefore consists of a sequence of red, green and blue light Sr, Sg and P, respectively. On account of the locally and temporally close proximity of the light proportions Sr, Sg and P emitted on the rear side, they cannot be resolved by any human observer and are perceived as a pixel composed of mixed light having corresponding light proportions Sr, Sg and P. By means of corresponding driving or illumination of the transmitted-light regions 7, 8, 9, the pixel can assume a (cumulative) color locus in the entire RGB color space.

The carrier 6 has a convexly shaped rear surface 17 and therefore also acts as a lens.

The carrier 6 is further configured in an exchangeable fashion, as indicated by the double-headed arrow, and for this purpose may be received in a corresponding receptacle of the projection device 1, e.g. an introduction or insertion receptacle (not illustrated).

The projection device 1 additionally has the possibility of also inserting at least one further carrier 18 into the beam path, here: behind the carrier 6. The carrier 18 e.g. has an array F of transmitted-light regions arranged identically to the carrier 6, but now the transmitted-light regions have a different function, e.g. have a polarizing layer 19.

Different transmitted-light regions may have different polarization properties, e.g. directed according to the type of polarization (circular, linear) and/or differently. A polarizing layer may also be assigned to a specific light color. It goes without saying that a polarizing layer may also be dispensed with for at least one transmitted-light region.

The transmitted-light regions 7 to 9 of the carrier 6 and the transmitted-light regions of the carrier 18 are arranged one behind another in the beam path of the light, such that at a specific point in time said beam path passes only through the maximum of one luminophore layer 14 or 15.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A projection device, comprising:
a light generator for generating primary light by means of at least one light source;
at least one carrier having a plurality of transmitted-light regions, the front sides of which can be irradiated by the primary light and the rear sides of which emit light, which transmitted-light regions have at least one first transmitted-light region which contains luminophore and the front side of which can be illuminated by the primary light and the rear side of which emits wavelength-converted secondary light; and
at least one deflection mirror for deflecting the primary light of the light generator onto a respective transmitted-light region;
wherein the transmitted-light regions have at least one further, wavelength-invariant transmitted-light region.

2. The projection device of claim 1,
wherein at least one further transmitted-light region comprises luminophore that differs from the luminophore of the first transmitted-light region.

3. The projection device of claim 1,
wherein at least one further transmitted-light region is at least one of a transparent and a diffuse transmitted-light region.

4. The projection device of claim 1,
wherein at least one further transmitted-light region has a polarizer.

5. The projection device of claim 1,
wherein the transmitted-light regions are arranged uniformly in a matrix-like fashion.

6. The projection device of claim 1,
wherein the transmitted-light regions are arranged uniformly in a matrix-like fashion in partial areas.

7. The projection device of claim 6, further comprising:
two partial areas having an identical arrangement of transmitted-light regions;
wherein the transmitted-light regions of the two partial areas emit light of anaglyphic complementary colors.

8. The projection device of claim 1,
wherein the at least one carrier is exchangeable.

9. The projection device of claim 8,
wherein the at least one carrier is insertable.

10. The projection device of claim 1,
wherein the at least one carrier comprises a plurality of carriers arranged one behind another.

11. The projection device of claim 10,
wherein the transmitted-light regions of different carriers are arranged in series one behind another and only one transmitted-light region of a series comprises luminophore.

12. The projection device of claim 1,
wherein at least one carrier is a light-transmissive plate.

13. The projection device of claim 1,
wherein at least one carrier is an optical transmitted-light element.

14. The projection device of claim 13,
wherein the optical transmitted-light element is a lens.

15. A method for operating a projection device,
the projection device comprising:
a light generator for generating primary light by means of at least one light source;
at least one carrier having a plurality of transmitted-light regions, the front sides of which can be irradiated by the primary light and the rear sides of which emit light, which transmitted-light regions have at least one first transmitted-light region which contains luminophore and the front side of which can be illuminated by the primary light and the rear side of which emits wavelength-converted secondary light; and
at least one deflection mirror for deflecting the primary light of the light generator onto a respective transmitted-light region;
wherein the transmitted-light regions have at least one further, wavelength-invariant transmitted-light region;
the method comprising:
individually illuminating the transmitted-light regions.
